(19) United States
(12) Patent Application Publication
(10) Pub. No.: US 2025/0318025 A1
(43) Pub. Date: Oct. 9, 2025

(54) MICROWAVE-BASED HEATING DEVICE

(71) Applicant: POSTECH RESEARCH AND BUSINESS DEVELOPMENT FOUNDATION, Pohang-si (KR)

(72) Inventors: Hyunsang HWANG, Pohang-si (KR); Jongseon SEO, Pohang-si (KR)

(73) Assignee: POSTECH RESEARCH AND BUSINESS DEVELOPMENT FOUNDATION, Pohang-si (KR)

(21) Appl. No.: 19/169,945

(22) Filed: Apr. 3, 2025

(30) Foreign Application Priority Data
Apr. 8, 2024 (KR) 10-2024-0047616

(51) Int. Cl. H05B 6/74; H05B 6/70

(52) U.S. Cl. CPC H05B 6/74; H05B 6/707

(57) ABSTRACT

A microwave-based heating device is capable of uniformly heating a heating-target object by adjusting a difference between phases of waveguides based on lengths of waveguides so that an electric field distribution rotates over time. The microwave-based heating device includes a chamber having a first space for receiving a heating-target object; waveguides respectively extending in a length direction of side surfaces of the chamber, where each waveguide has a second space through which a microwave travels; and a block member disposed inside each of the chamber and the waveguides to occupy the first space and the second space. At least one waveguide has a different length from a length of each of the other waveguides such that a difference between phases of the microwaves respectively travelling through the waveguides occurs. When the microwaves are applied to the waveguides, an electric field distribution generated in the chamber rotates over time.

### CROSS-REFERENCE TO RELATED APPLICATION

This application claims priority from Korean Patent Application No. 10-2024-0047616 filed on Apr. 8, 2024, in the Korean Intellectual Property Office, and all the benefits accruing therefrom under 35 U.S.C. 119, the contents of which in its entirety are herein incorporated by reference.

### BACKGROUND

### Field

The present disclosure relates to a microwave-based heating device, and more particularly, to a microwave-based heating device capable of uniformly heating a heating-target object.

### Description of Related Art

The heating using microwaves includes heating due to vibration of dipoles in the heating-target object (dielectric polarization loss) and heat generation due to movement of electrons in the heating-target object (Ohmic conduction loss).

When heating the heating-target object using the microwaves, the heating temperature is proportional to the square of the electric field strength. However, a conventional microwave-based heating device has a disadvantage in that a non-uniform electric field distribution occurs due to a standing wave that occurs when microwaves are propagated in the heating-target object. This causes the microwave-based heating device to fail to uniformly heat the heating-target object.

### SUMMARY

A purpose to be achieved by the present disclosure is to provide a microwave-based heating device capable of securing efficient heating performance based on the design of a microwave chamber and a waveguide.

In addition, a purpose of the present disclosure is to provide a microwave-based heating device which adjusts the difference between phases of the waveguides based on the lengths of the waveguides to rotate the electric field distribution in one direction in a chamber over time so as to uniformly heat a heating-target object.

In addition, a purpose of the present disclosure is to provide a microwave-based heating device which achieves uniform heating regardless of a heat treatment time for heating a heating-target object, thereby improving stability and efficiency in a heating process using microwaves, and ensuring reliable use in various application fields.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims or combinations thereof.

A microwave-based heating device according to an embodiment of the present disclosure comprises: a chamber having a first space defined therein for receiving a heating-target object therein; at least two waveguides respectively extending from respective non-central positions in a length direction of at least two side surfaces of the chamber, wherein each of the at least two waveguides has a second space defined therein through which a microwave travels; and a block member disposed inside each of the chamber and the waveguides so as to occupy the first space of the chamber and the second space of each of the waveguides, wherein at least one of the waveguides has a different length from a length of each of the others of the waveguides such that a difference between phases of the microwaves respectively travelling through the at least two waveguides occurs, wherein when the microwaves are applied to the at least two waveguides, an electric field distribution generated in the chamber rotates over time.

According to the present disclosure, the uniform heating of the heating-target object may be realized via the design of the microwave chamber and the waveguide in order to remove the non-uniform heating of the object in the conventional microwave-based heating device.

The microwave-based heating device of the present disclosure minimizes destructive interference and maximizes constructive interference by adjusting the phase difference between the phases of the microwaves respectively incident to the plurality of waveguides, thereby providing the best uniform heating performance, especially in the central region of the chamber.

The microwave-based heating device of the present disclosure mainly may have excellent applicability to heating treatment in various fields such as heat treatment on the semiconductor, nanomaterial, and metal alloy as well as heating and cooking of the food.

According to embodiments of the present disclosure, efficient heating performance may be secured via the design of the microwave chamber and the waveguides.

In addition, the phase difference between the phases of the microwaves respectively travelling through the waveguides is adjusted via adjustment of the lengths of the waveguides so that the electric field distribution in the chamber rotates in one direction over time, thereby uniformly heating the heating-target object.

In addition, the uniform heating performance is achieved regardless of the heat treatment time for heating the heating-target object, thereby improving stability and efficiency in the heating treatment using the microwaves. In addition, reliable use of the device in various applications may be guaranteed.

In addition to the above-described effects, the specific effects of the present disclosure will be described together with the detailed matters for implementing the present disclosure.

### BRIEF DESCRIPTION OF DRAWINGS

FIG. 1 illustrates a structure of each of a microwave chamber and a waveguide of a microwave-based heating device according to an embodiment.

FIG. 2 illustrates an electric field distribution simulation when a microwave-based heating device including a microwave chamber and a waveguide respectively having different structures from respective structures of those of the microwave-based heating device according to an embodiment of the present disclosure.

FIG. 3 illustrates an electric field distribution simulation when positions of waveguide are different from those in FIG. 2 in a microwave-based heating device according to an embodiment of the present disclosure.

FIG. 4 illustrates an electric field distribution simulation in a microwave-based heating device according to an embodiment of the present disclosure of FIG. 3 in which lengths of the waveguides are different from each other.

FIG. 5 illustrates a simulation of the electric field distribution when the microwave-based heating device of FIG. 4 having a block member according to an embodiment of the present disclosure is used.

FIG. 6 illustrates an electric field vector angular direction over time in a central portion of the chamber in the microwave-based heating device of FIG. 5 according to an embodiment of the present disclosure.

FIG. 7 is a graph showing that the electric field vector angular direction rotates over time in a clockwise direction in the microwave-based heating device of FIG. 5 according to an embodiment of the present disclosure.

FIG. 8 illustrates an electric field distribution simulation result based on whether a microwave-based heating device is designed in a manner according to an embodiment of the present disclosure.

FIG. 9A illustrates a simulation result of the electric field distribution over time in a microwave-based heating device according to an embodiment of the present disclosure.

FIG. 9B shows a range having an electric field distribution within an error range of 5% and 10% from the maximum electric field value of FIG. 9A.

FIG. 10 illustrates structures of a microwave chamber and a waveguide of a microwave-based heating device according to another embodiment.

FIG. 11 illustrates a result of the electric field distribution simulation in the microwave-based heating device according to another embodiment of the present disclosure.

### DETAILED DESCRIPTIONS

Advantages and features of the present disclosure, and a method of achieving the advantages and features will become apparent with reference to embodiments described later in detail together with the accompanying drawings. However, the present disclosure is not limited to the embodiments as disclosed below, but may be implemented in various different forms. Thus, these embodiments are set forth only to make the present disclosure complete, and to completely inform the scope of the present disclosure to those of ordinary skill in the technical field to which the present disclosure belongs, and the present disclosure is only defined by the scope of the claims.

For simplicity and clarity of illustration, elements in the drawings are not necessarily drawn to scale. The same reference numbers in different drawings represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure. Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

A shape, a size, a ratio, an angle, a number, etc. disclosed in the drawings for illustrating embodiments of the present disclosure are illustrative, and the present disclosure is not limited thereto.

The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise. It will be further understood that the terms “comprise”, “comprising”, “include”, and “including” when used in the present disclosure, specify the presence of the stated features, integers, operations, elements, and/or components, but do not preclude the presence or addition of one or more other features, integers, operations, elements, components, and/or portions thereof.

In addition, it will also be understood that when a first element or layer is referred to as being present “on” a second element or layer, the first element may be disposed directly on the second element or may be disposed indirectly on the second element with a third element or layer being disposed between the first and second elements or layers. It will be understood that when an element or layer is referred to as being “connected to”, or “connected to” another element or layer, it may be directly on, connected to, or connected to the other element or layer, or one or more intervening elements or layers may be present. In addition, it will also be understood that when an element or layer is referred to as being “between” two elements or layers, it may be the only element or layer between the two elements or layers, or one or more intervening elements or layers may also be present.

In descriptions of temporal relationships, for example, temporal precedent relationships between two events such as “after”, “subsequent to”, “before”, etc., another event may occur therebetween unless “directly after”, “directly subsequent” or “directly before” is not indicated.

When a certain embodiment may be implemented differently, a function or an operation specified in a specific block may occur in a different order from an order specified in a flowchart. For example, two blocks in succession may be actually performed substantially concurrently, or the two blocks may be performed in a reverse order depending on a function or operation involved.

It will be understood that, although the terms “first”, “second”, “third”, and so on may be used herein to describe various elements, components, regions, layers and/or periods, these elements, components, regions, layers and/or periods should not be limited by these terms. These terms are used to distinguish one element, component, region, layer or section from another element, component, region, layer or period. Thus, a first element, component, region, layer or section as described under could be termed a second element, component, region, layer or period, without departing from the spirit and scope of the present disclosure.

The features of the various embodiments of the present disclosure may be partially or entirely combined with each other, and may be technically associated with each other or operate with each other. The embodiments may be implemented independently of each other and may be implemented together in an association relationship.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, a microwave-based heating device capable of uniformly heating a heating-target object is disclosed.

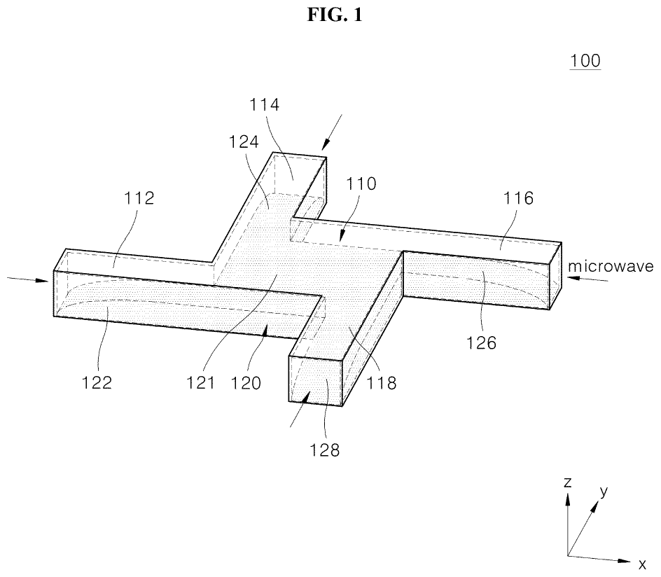

FIG. 1 illustrates a structure of each of a microwave chamber and a waveguide of a microwave-based heating device according to an embodiment.

Referring to FIG. 1, a microwave-based heating device 100 according to an embodiment includes a chamber 110, multiple waveguides 112, 114, 116, and 118, and a block member 120.

A space for accommodating therein a heating-target object (not shown) is defined inside the chamber 110. For example, the chamber 110 may be formed in a rectangular parallelepiped shape. In addition, longitudinal and transverse lengths of the chamber 110 may be equal to each other. In addition, a vertical dimension of the chamber 110 may be smaller than each of the longitudinal and transverse lengths of the chamber 110. In addition, the vertical dimension of the chamber 110 may be adjusted based on a vertical dimension of the block member 120 disposed inside the chamber 110. In addition, each of the longitudinal and transverse lengths of the chamber 110 may be larger than a length of each of the multiple waveguides 112, 114, 116, and 118.

The chamber 110 acts as a heating furnace for heating the heating-target object using microwaves incident thereto from the outside, and has an empty space defined therein to accommodate therein the heating-target object and the block member 120. In addition, a microwave propagation channel may be defined between an inner wall of the chamber 110 and the block member 120 such that the microwaves may travel through the channel.

Each opening connected to each of the multiple waveguides 112, 114, 116, and 118 may be defined in one side portion of each of four side surfaces of the chamber 110. A shape of each of the openings may correspond to a cross-sectional shape of each of the multiple waveguides 112, 114, 116, and 118.

Each of the multiple waveguides 112, 114, 116, and 118 has a space defined therein through which the microwave propagates, and each of the multiple waveguides 112, 114, 116, and 118 extends from one side portion of each of the side surfaces of the chamber 100. That is, each of the multiple waveguides 112, 114, 116, and 118 extends from not a center but one side portion of each of the side surfaces of the chamber 100.

The multiple waveguides 112, 114, 116, and 118 may include first to fourth waveguides 112, 114, 116, and 118. Each of the first to fourth waveguides 112, 114, 116, and 118 may be connected to one side portion of each of the four side surfaces of the rectangular parallelepiped chamber 110.

For example, the first waveguide 112 may be connected to one side portion of a first side surface of the chamber 110, and the second waveguide 114 may be connected to one side portion of a second side surface of the chamber 110. The third waveguide 116 may be connected to one side portion of a third side surface of the chamber 110, and the fourth waveguide 118 may be connected to one side portion of a fourth side surface of the chamber 110. That is, each of the first to fourth waveguides 112, 114, 116, and 118 may extend from an asymmetrical position, that is, one side portion of each of the side surfaces of the chamber 110.

At least one of the first to fourth waveguides 112, 114, 116, and 118 may be formed to have a different length from a length of each of the others thereof. A difference between phases of the sources of the microwaves may occur by adjusting the lengths of the first to fourth waveguides 112, 114, 116, and 118.

In one example, the first waveguide 112 and the third waveguide 116 may have the same length, that is, a first length, while the second waveguide 114 and the fourth waveguide 118 may have the same length, that is, a second length different from the first length. In this regard, the first waveguide 112 and the third waveguide 116 are respectively connected to the side surfaces opposite to and facing each other among the four side surfaces of the rectangular parallelepiped chamber 110. In addition, the second waveguide 114 and the fourth waveguide 118 are respectively connected to the side surfaces opposite to and facing each other among the four side surfaces of the rectangular parallelepiped chamber 110.

For example, each of the first waveguide 112 and the third waveguide 116 may have the first length, while each of the second waveguide 114 and the fourth waveguide 118 may have the second length, wherein the second length may be larger by ½ of a microwave wavelength than the first length. In this regard, the microwave may be applied from a microwave generator (not shown).

The microwave generator may generate microwaves having a predetermined frequency f, a wavelength λ, and power, and may apply the generated microwaves to at least one of the first to fourth waveguides 112, 114, 116, and 118. For example, a frequency in a range of 300 MHz to 300 GHz may be used as the predetermined frequency f, and a wavelength in a range of 1.0 mm to 1.0 m may be used as the predetermined wavelength λ.

The microwave generator may adjust the frequency, the wavelength, and the power of the microwaves to be input to the at least one waveguide based on the heating performance of the microwave-based heating device 100.

Further, returning to the description about the first to fourth waveguides 112, 114, 116, and 118, in another example, the first waveguide 112 may be formed to have the first length, each of the second waveguide 114 and the fourth waveguide 118 may be formed to have the second length larger than the first length, and the third waveguide 116 may be formed to have a third length larger than the second length.

In this case, for example, the first waveguide 112 may have the first length, each of the second waveguide 114 and the fourth waveguide 118 may have a length larger by ½ of the microwave wavelength than the first length, and the third waveguide 116 may have a length larger by the wavelength of the microwave than the first length.

Each of the first to fourth waveguides 112, 114, 116, and 118 may be formed such that one end thereof is connected to each opening defined in one side portion of each of the side surfaces of the chamber 110. In this regard, the first to third waveguides 112 and 116 may be respectively connected to the two opposing side surfaces facing each other of the chamber 110 such that the first to third waveguides 112 and 116 non-overlap each other in a direction in which the two opposing side surfaces face each other. The second to fourth waveguides 114 and 118 may be respectively connected to the two opposing side surfaces facing each other of the chamber 110 such that the second to fourth waveguides 114 and 118 non-overlap each other in a direction in which the two opposing side surfaces face each other. In this regard, the direction in which the two opposing side surfaces respectively connected to the first to third waveguides 112 and 116 may be a first direction, for example, a x-direction in FIG. 1. The direction in which the two opposing side surfaces respectively connected to the second to fourth waveguides 114 and 118 may be a second direction, for example, a y-direction in FIG. 1.

The first to fourth waveguides 112, 114, 116, and 118 may be made of the same material as that of the chamber 110 or a different material from that of the chamber 110. In addition, the first to fourth waveguides 112, 114, 116, and 118 may be integrally formed with the chamber 110 or may be formed to be coupled to or removed from the chamber 110.

Each of the first to fourth waveguides 112, 114, 116, and 118 may be formed to have an empty space defined therein through which the microwave propagates. For example, the first to fourth waveguides 112, 114, 116, and 118 may transmit the microwaves received from the microwave generator therethrough to the inside of the chamber 110.

The first waveguide 112 may be formed to extend in the −x-axis direction from one side portion of the first side surface of the chamber 110. The second waveguide 114 may be formed to extend in the +y-axis direction from one side portion of the second side surface of the chamber 110. The third waveguide 116 may be formed to extend in the +x-axis direction from one side portion of the third side surface of the chamber 110. The fourth waveguide 118 may be formed to extend from one side portion of the fourth side surface of the chamber 110 in the −y-axis direction.

Each of the first to fourth waveguides 112, 114, 116, and 118 may be formed in a hollow shape so that microwaves may propagate therethrough. In addition, each of the first to fourth waveguides 112, 114, 116, and 118 may have a rectangular cross-sectional view as cut in a perpendicular direction to the traveling direction of the microwave.

The block member 120 is disposed inside each of the chamber 110 and the first to fourth waveguides 112, 114, 116, and 118 to occupy a portion of a first space defined inside the chamber 110 and a portion of a second space defined inside each of the first to fourth waveguides 112, 114, 116, and 118.

The block member 120 includes a first member 121 and second members 122, 124, 126, and 128. The first member 121 is formed to have a flat upper surface having an uniform vertical dimension and to occupy a portion of the first space of the chamber 100.

Each of the second members 122, 124, 126, and 128 is formed to be inclined so that a vertical dimension thereof is deceased as the second member extends in the longitudinal direction of each of the first to fourth waveguides 112, 114, 116, and 118 from the first member 121 toward an outer end of each of the first to fourth waveguides 112, 114, 116, and 118, and to occupy a portion of the second space of each of the first to fourth waveguides 112, 114, 116, and 118.

The block member 120 may be disposed inside the chamber 110 and the first to fourth waveguides 112, 114, 116, and 118 and may perform an operation of changing characteristics of the microwaves input to the first to fourth waveguides 112, 114, 116, and 118. The block member 120 may be integrally formed with the chamber 110 and the first to fourth waveguides 112, 114, 116, and 118, and thus may constitute a portion of an inner wall of the chamber 110 and the first to fourth waveguides 112, 114, 116, and 118 or may be independently formed in a separate manner therefrom.

The block member 120 may include the first member formed in a plate shape and disposed inside the chamber 110, and the second member formed to be inclined such that the vertical dimension thereof decreases as the second member extends from the first member toward an outer end thereof in the longitudinal direction of each of the first to fourth waveguides 112, 114, 116, and 118.

The block member 120 may be made of the same material as that of the chamber 110 or may be made of a different material from that thereof. For example, the block member 120 may be made of a metal material or a non-metal material having durability and/or heat resistance. The first member may be formed in a plate shape corresponding to a shape of the chamber 110. In an example, the first member may be formed in a square plate shape having a constant thickness.

The first member may be disposed in a lower portion of an inner space of the chamber 110 so as to reduce a vertical dimension (i.e., a dimension in a z-axis direction) of a space of the chamber 110 through which the microwaves travel, and thus may serve to change the wavelength of the microwaves traveling through the space having the reduced vertical dimension.

That is, when the microwave travels through the travel space of the microwave defined between an upper surface of the first member and an upper inner surface of the chamber 110, the first member may allow the wavelength of the microwave to be larger than the wavelength of the microwave before entering the microwave travel space. Accordingly, the heating-target object placed in the inner space of the chamber 110 through which the microwaves travel may be entirely and uniformly heated.

Each of the second members may be formed to extend from each side surface of the first member in the longitudinal direction of each of the first to fourth waveguides 112, 114, 116, and 118. A thickness of the second member may increase as the second member extends toward the chamber 110 and decreases as the second member extends toward the waveguide inlet. Accordingly, the second member may serve to gradually reduce the z-axis directional or vertical dimension of the inner space of the waveguide as the second member extends from the inlet of the waveguide toward the chamber.

A bottom surface of the second member may be formed in a flat and non-inclined shape, and the inclined upper surface thereof may be formed in a flat shape or a curved shape. The second member may improve the transmissibility of the microwaves by reducing reflection of the microwaves incident from the waveguide inlet. In addition, the second member may perform an impedance matching function by gradually reducing the z-axis directional or vertical dimension of the inner space of the waveguide as the second member extends from the inlet of the waveguide toward the chamber. In addition, the second member may perform a function of matching the wavelength of the microwave in the inside of the waveguide and the wavelength of the microwave in the inside of the chamber with each other by gradually reducing the z-axis directional or vertical dimension of the inner space of the waveguide as the second member extends from the inlet of the waveguide toward the chamber.

A difference between the phases of the sources of the microwaves may be adjusted based on different lengths of the first to fourth waveguides 112, 114, 116, and 118. Adjusting the difference between phases of the sources of the microwaves may allow a uniform electric field distribution to be generated inside the chamber 110 regardless of the microwave treatment time.

For example, the microwave traveling through the waveguide parallel to the x-axis may have a phase difference of 90 degrees, and the microwave traveling through the waveguide parallel to the y-axis may have a phase difference of 180 degrees. Thus, the electric field distribution generated inside the chamber 110 may rotate in one direction (e.g., clockwise) over time.

The microwave-based heating device 100 may maintain the error of the electric field distribution in the chamber 110 at a level below a reference value, and may adjust the error of the electric field distribution by adjusting the size of the chamber 110.

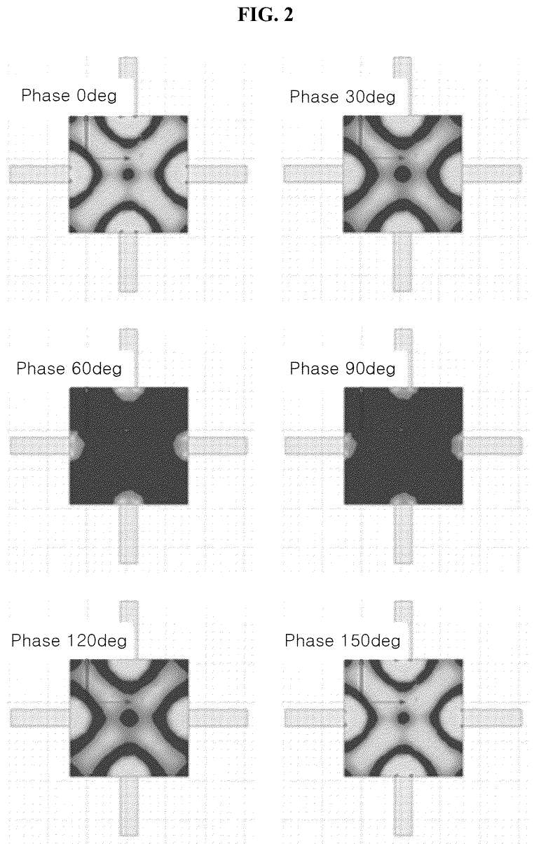

FIG. 2 illustrates an electric field distribution simulation when a microwave-based heating device including a microwave chamber and a waveguide respectively having different structures from respective structures of those of the microwave-based heating device according to an embodiment of the present disclosure.

In FIG. 2, the microwave-based heating device includes a square-shaped chamber, and first to fourth waveguides respectively connected to respective centers of the four side surfaces of the chamber, and extending in respective longitudinal directions of the first to fourth waveguides. The microwave-based heating device having this structure has a non-uniform electric field distribution problem due to a standing wave effect appearing in the microwave-based heating device. The present disclosure is intended to solve this non-uniform electric field distribution problem.

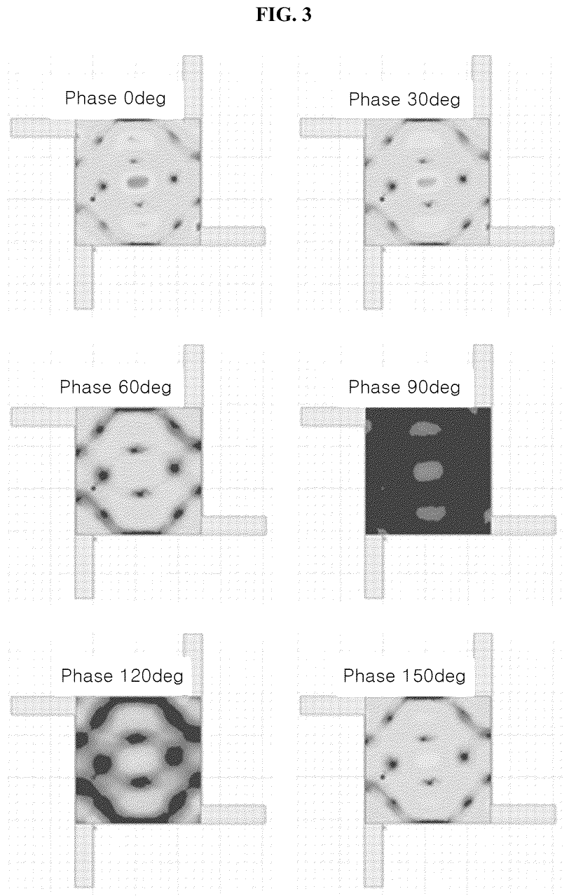

FIG. 3 illustrates an electric field distribution simulation when positions of waveguides are different from those in FIG. 2 in a microwave-based heating device according to an embodiment of the present disclosure.

The microwave-based heating device in FIG. 3 has a structure in which the first to fourth waveguides have the same length and no block member is disposed. FIG. 3 shows a result of performing simulation when the microwave-based heating device in which the first to fourth waveguides have the same length and no block member is disposed is used. It may be identified that the non-uniform electric field distribution is generated as shown in FIG. 3.

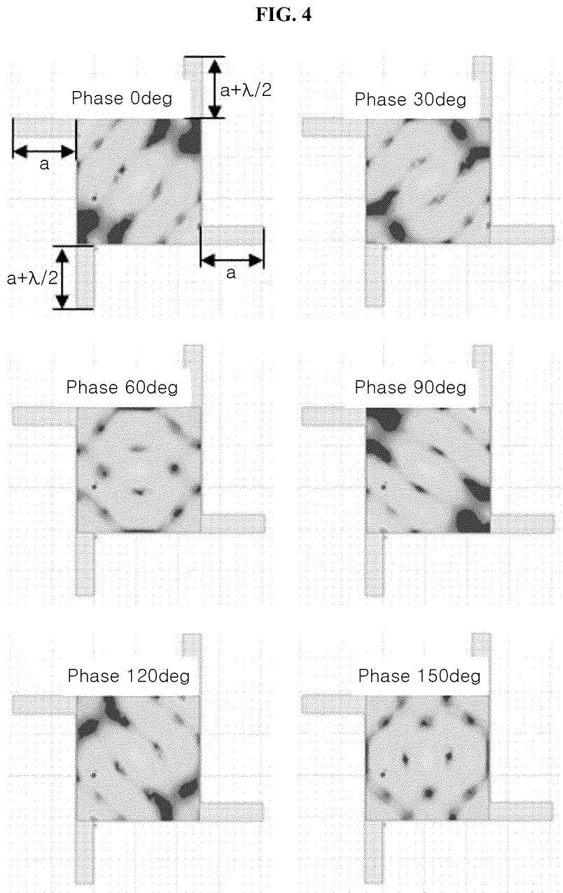

FIG. 4 illustrates an electric field distribution simulation in a microwave-based heating device according to an embodiment of the present disclosure of FIG. 3 in which lengths of the waveguides are different from each other.

The simulation result of FIG. 4 is a simulation result under a condition in which the lengths of the first to fourth waveguides are different from each other in the microwave-based heating device of FIG. 3 in which the block member is not disposed. It may be identified that the non-uniform electric field distribution occurs over time as shown in FIG. 4.

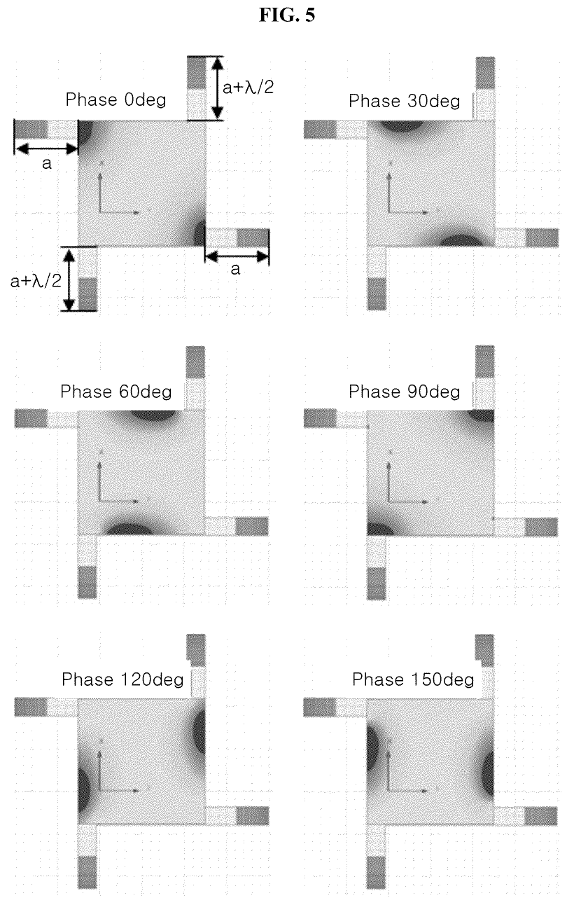

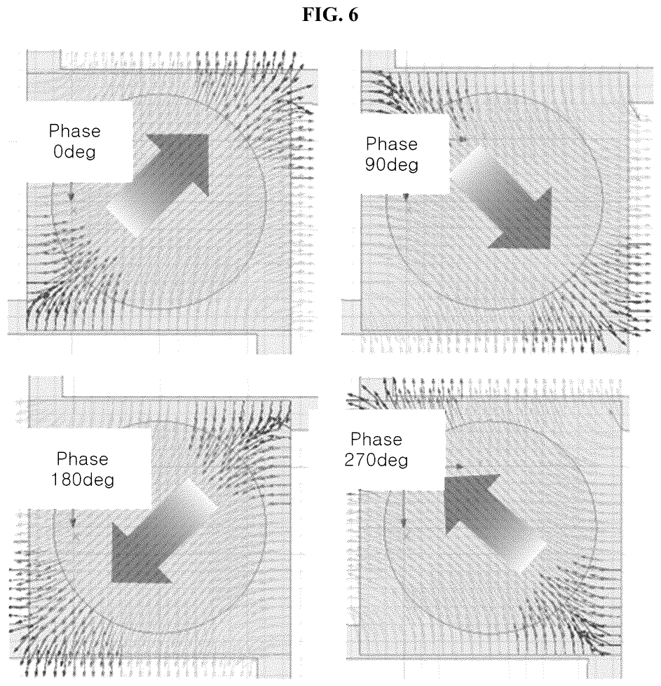

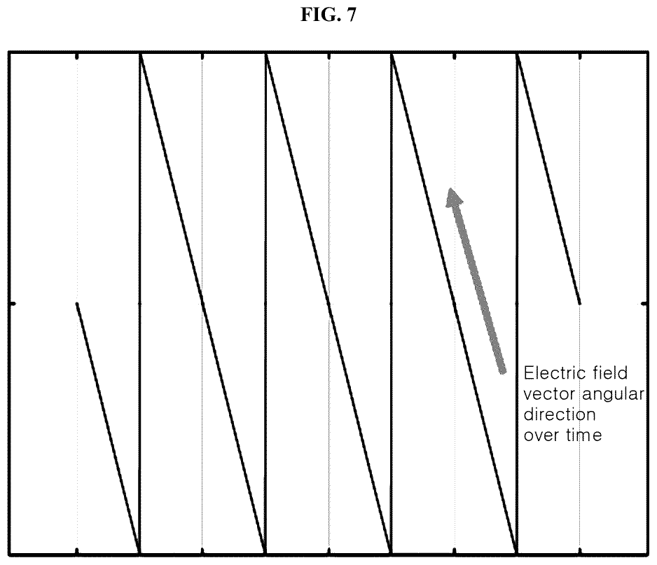

FIG. 5 illustrates a simulation of the electric field distribution when the microwave-based heating device of FIG. 4 having the block member according to an embodiment of the present disclosure is used. FIG. 6 illustrates an electric field vector angular direction over time in a central portion of the chamber in the microwave-based heating device of FIG. 5 according to an embodiment of the present disclosure. FIG. 7 is a graph showing that the electric field vector angular direction rotates over time in a clockwise direction in the microwave-based heating device of FIG. 5 according to an embodiment of the present disclosure. The simulation result of FIG. 5 shows a simulation result under a condition in which the lengths of the first to fourth waveguides are different from each other and the block member is disposed in the microwave-based heating device in which the first to fourth waveguides are respectively connected to respective non-central positions, that is, one side end of the four side surfaces of the chamber. It may be identified that the uniform electric field distribution as shown in FIG. 5 is achieved compared to FIGS. 3 and 4. In addition, the simulation result in which the electric field distribution rotates over time is identified.

The microwave traveling through the waveguide parallel to the x-axis has a phase difference of 90 degrees. The microwave traveling through the waveguide parallel to the y-axis has a phase difference of 180 degrees. This indicates that the electric field distribution rotates in 0 degree, 90 degrees, 180 degrees, and 270 degrees phases in the chamber 110 over time.

In this manner, the present disclosure focuses on solving the non-uniform electric field distribution problem due to the standing wave effect appearing in the conventional microwave-based heating device. Each waveguide is positioned at the rightmost or leftmost side of each side surface of the chamber, and the length adjustment of the waveguides is achieved such that the difference between phases of the microwave sources occurs, thereby adjusting the propagation path of the microwaves, thereby allowing the distribution of the electric field to rotate over time such that the uniform electric field distribution may be achieved.

To this end, each waveguide is positioned at the right or left end of each side surface of the chamber and the lengths of the waveguides are different from each other to control the difference between the phases of the microwaves, thereby enabling the uniform heating of the object. Under a certain phase difference condition (in an embodiment, the microwave travelling through the waveguide parallel to the x-axis has a phase difference of 90 degrees and the microwave travelling through the waveguide parallel to the y-axis has a phase difference of 180 degrees), the electric field distribution in the microwave-based heating device rotates clockwise over time, thereby enabling the uniform heating of the object.

Achieving the uniform heating of the object by the microwave-based heating device regardless of the heat treatment time via the above design and phase difference control may result in improvement of the stability and efficiency of the process and in ensuring of the reliable use of the device in various applications.

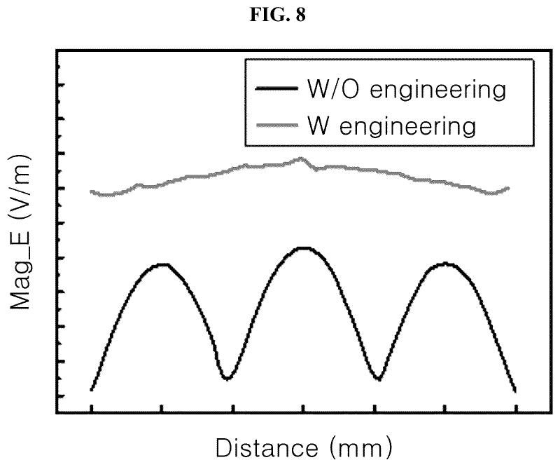

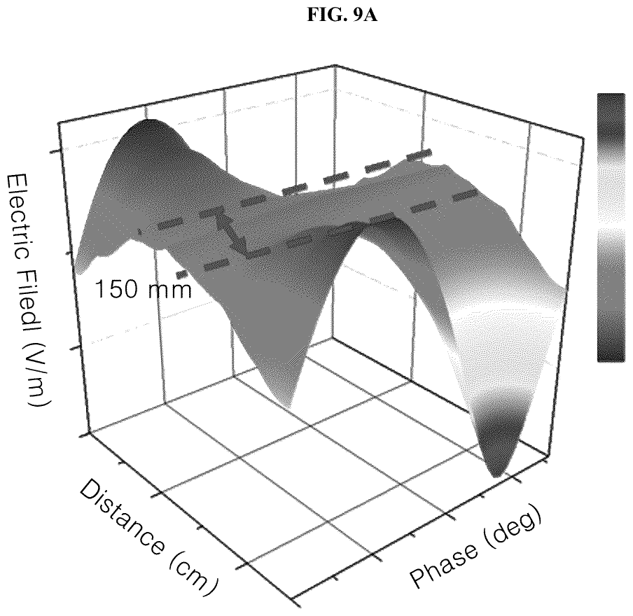

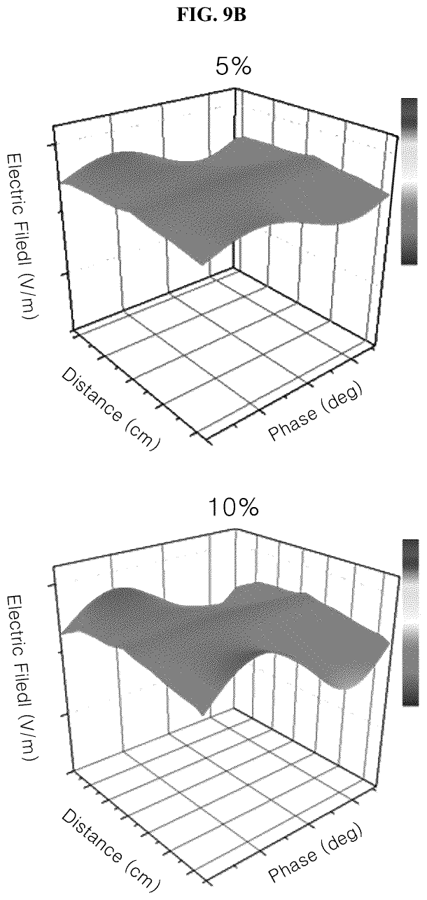

FIG. 8 illustrates an electric field distribution simulation result based on whether a microwave-based heating device is designed in a manner according to an embodiment of the present disclosure. FIG. 9A illustrates a simulation result of the electric field distribution over time in a microwave-based heating device according to an embodiment of the present disclosure. FIG. 9B shows a range having an electric field distribution within an error range of 5% and 10% from the maximum electric field value of FIG. 9A.

Such a microwave-based heating device may have the uniform electric field distribution. The electric field distribution in the device is uniform over time. In addition, the electric field may be maintained to have an electric field distribution within an error range of 5% and 10% from the maximum electric field value.

For example, the microwave-based heating device may have a uniform electric field distribution with a 150 mm width.

As described above, the present disclosure relates to a method for allowing the distribution of the electric field inside the chamber to be uniform, based on the design of the chamber and the waveguide of the microwave-based heating device and the difference between phases of the microwaves.

The field of use of the present disclosure is about the heating device using the microwaves. According to the present disclosure, the uniform heating of the heating-target object may be realized via the design of the microwave chamber and the waveguide in order to remove the non-uniform heating of the object in the conventional microwave-based heating device.

The microwave-based heating device of the present disclosure minimizes destructive interference and maximizes constructive interference by adjusting the phase difference between the phases of the microwaves respectively incident to the plurality of waveguides, thereby providing the best uniform heating performance, especially in the central region of the chamber.

The microwave-based heating device of the present disclosure mainly may have excellent applicability to heating treatment in various fields such as heat treatment on the semiconductor, nanomaterial, and metal alloy as well as heating and cooking of the food.

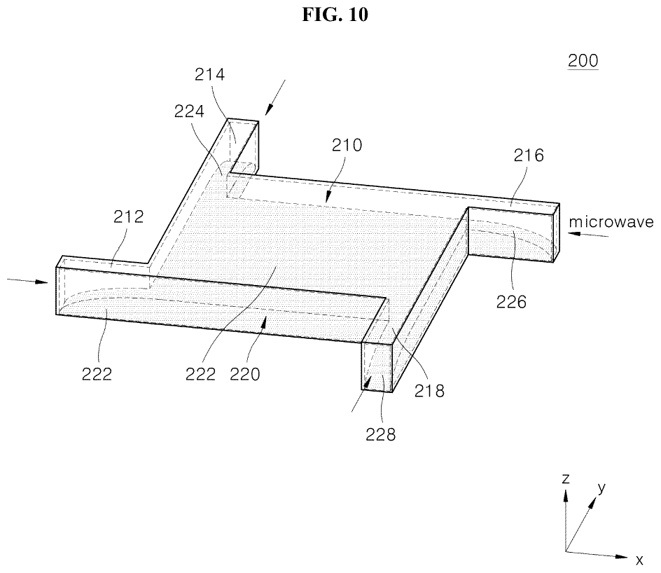

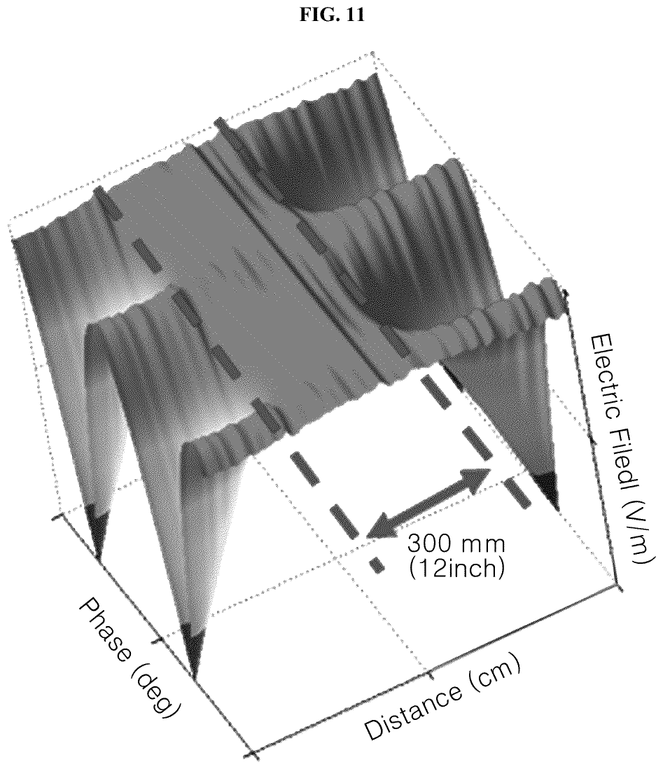

FIG. 10 illustrates structures of a microwave chamber and a waveguide of a microwave-based heating device according to another embodiment. FIG. 11 illustrates a result of the electric field distribution simulation in a microwave-based heating device according to another embodiment of the present disclosure.

Referring to FIGS. 10 and 11, a microwave-based heating device 200 according to another embodiment includes a chamber 210, multiple waveguides 212, 214, 216, and 218, and a block member 220.

The chamber 210 is formed to have larger longitudinal and transverse lengths of the chamber 210, compared to the embodiment of FIG. 1.

Each of the first to fourth waveguides 212, 214, 216, and 218 may be connected to one side portion of each of side surfaces of the chamber 210. For example, the first waveguide 212 may be connected to one side portion of a first side surface of the chamber 210, and the second waveguide 214 may be connected to one side portion of a second side surface of the chamber 210. The third waveguide 216 may be connected to one side portion of a third side surface of the chamber 210, and the fourth waveguide 218 may be connected to one side portion of a fourth side surface of the chamber 210.

At least one of the first to fourth waveguides 212, 214, 216, and 218 may be formed to have a different length from a length of each of the others thereof. A difference between phases of the sources of the microwaves may occur by adjusting the lengths of the first to fourth waveguides 212, 214, 216, and 218.

In the embodiment of FIG. 10, in one example, the first waveguide 212 and the third waveguide 216 may have the same length, that is, a first length, while the second waveguide 214 and the fourth waveguide 218 may have the same length, that is, a second length different from the first length. In this regard, the first waveguide 212 and the third waveguide 216 are respectively connected to the side surfaces opposite to and facing each other among the four side surfaces of the rectangular parallelepiped chamber 210. In addition, the second waveguide 214 and the fourth waveguide 218 are respectively connected to the side surfaces opposite to and facing each other among the four side surfaces of the rectangular parallelepiped chamber 210. In one example, the second length may be larger than the first length. In one example, the second length may be larger by ½ of the microwave wavelength than the first length.

The microwave generator may generate microwaves having a predetermined frequency f, a wavelength λ, and power, and may apply the generated microwaves to at least one of the first to fourth waveguides 212, 214, 216, and 218. For example, a frequency in a range of 300 MHz to 300 GHz may be used as the predetermined frequency f, and a wavelength in a range of 2.0 mm to 2.0 m may be used as the predetermined wavelength λ.

The microwave generator may adjust the frequency, the wavelength, and the power of the microwaves to be input to the at least one waveguide based on the heating performance of the microwave-based heating device 200.

In another example, the first waveguide 212 may be formed to have the first length, each of the second waveguide 214 and the fourth waveguide 218 may be formed to have the second length larger than the first length, and the third waveguide 216 may be formed to have a third length larger than the second length. In this case, for example, the first waveguide 212 may have the first length, each of the second waveguide 214 and the fourth waveguide 218 may have a length larger by ½ of the microwave wavelength than the first length, and the third waveguide 216 may have a length larger by the wavelength of the microwave than the first length.

Each of the first to fourth waveguides 212, 214, 216, and 218 may be formed such that one end thereof is connected to each opening defined in one side portion of each of the side surfaces of the chamber 210. In this regard, the first to third waveguides 212 and 216 may be respectively connected to the two opposing side surfaces facing each other of the chamber 210 such that the first to third waveguides 212 and 216 non-overlap each other in a direction in which the two opposing side surfaces face each other. The second to fourth waveguides 214 and 218 may be respectively connected to the two opposing side surfaces facing each other of the chamber 210 such that the second to fourth waveguides 214 and 218 non-overlap each other in a direction in which the two opposing side surfaces face each other. In this regard, the direction in which the two opposing side surfaces respectively connected to the first to third waveguides 212 and 216 may be a first direction, for example, a x-direction in FIG. 10. The direction in which the two opposing side surfaces respectively connected to the second to fourth waveguides 214 and 218 may be a second direction, for example, a y-direction in FIG. 10.

The block member 220 is disposed inside each of the chamber 210 and the first to fourth waveguides 212, 214, 216, and 218 to occupy a portion of a first space defined inside the chamber 210 and a portion of a second space defined inside each of the first to fourth waveguides 212, 214, 216, and 218.

The block member 220 includes a first member 221 and second members 222, 224, 226, and 228. The first member 221 is formed to have a flat upper surface having an uniform vertical dimension and to occupy a portion of the first space of the chamber 200. Each of the second members 222, 224, 226, and 228 is formed to be inclined so that a vertical dimension thereof is deceased as the second member extends in the longitudinal direction of each of the first to fourth waveguides 212, 214, 216, and 218 from the first member 221 toward an outer end of each of the first to fourth waveguides 212, 214, 216, and 218, and to occupy a portion of the second space of each of the first to fourth waveguides 212, 214, 216, and 218.

The block member 220 may be disposed inside the chamber 210 and the first to fourth waveguides 212, 214, 216, and 218 and may perform an operation of changing characteristics of the microwaves input to the first to fourth waveguides 212, 214, 216, and 218. The block member 220 may be integrally formed with the chamber 210 and the first to fourth waveguides 212, 214, 216, and 218, and thus may constitute a portion of an inner wall of the chamber 210 and the first to fourth waveguides 212, 214, 216, and 218 or may be independently formed in a separate manner therefrom.

The block member 220 may include the first member formed in a plate shape and disposed inside the chamber 210, and the second member formed to be inclined such that the vertical dimension thereof decreases as the second member extends from the first member toward an outer end thereof in the longitudinal direction of each of the first to fourth waveguides 212, 214, 216, and 218.

The block member 220 may be made of the same material as that of the chamber 210 or may be made of a different material from that thereof. For example, the block member 220 may be made of a metal material or a non-metal material having durability and/or heat resistance. The first member may be formed in a plate shape corresponding to a shape of the chamber 210. In an example, the first member may be formed in a square plate shape having a constant thickness.

A difference between the phases of the sources of the microwaves may be adjusted based on different lengths of the first to fourth waveguides 212, 214, 216, and 218. Adjusting the difference between phases of the sources of the microwaves may allow a uniform electric field distribution to be generated inside the chamber 210 regardless of the microwave treatment time. For example, the microwave traveling through the waveguide parallel to the x-axis may have a phase difference of 90 degrees, and the microwave traveling through the waveguide parallel to the y-axis may have a phase difference of 280 degrees. Thus, the electric field distribution generated inside the chamber 210 may rotate in one direction (e.g., clockwise) over time.

For example, the microwave-based heating devices may have a uniform electric field distribution with a 300 mm width.

According to embodiments of the present disclosure, efficient heating performance may be secured via the design of the microwave chamber and the waveguides.

In addition, the phase difference between the phases of the microwaves respectively travelling through the waveguides is adjusted via adjustment of the lengths of the waveguides so that the electric field distribution in the chamber rotates in one direction over time, thereby uniformly heating the heating-target object.

In addition, the uniform heating performance is achieved regardless of the heat treatment time for heating the heating-target object, thereby improving stability and efficiency in the heating treatment using the microwaves. In addition, reliable use of the device in various applications may be guaranteed.

According to an aspect of the present disclosure, a microwave-based heating device comprises: a chamber having a first space defined therein for receiving a heating-target object therein; at least two waveguides respectively extending from respective non-central positions in a length direction of at least two side surfaces of the chamber, wherein each of the at least two waveguides has a second space defined therein through which a microwave travels; and a block member disposed inside each of the chamber and the waveguides so as to occupy the first space of the chamber and the second space of each of the waveguides, wherein at least one of the waveguides has a different length from a length of each of the others of the waveguides such that a difference between phases of the microwaves respectively travelling through the at least two waveguides occurs, wherein when the microwaves are applied to the at least two waveguides, an electric field distribution generated in the chamber rotates over time.

In accordance with some embodiments of the present disclosure, the chamber is formed in a rectangular parallelepiped shape.

In accordance with some embodiments of the present disclosure, a longitudinal length and a transverse length of the chamber in a plan view of the chamber are equal to each other.

In accordance with some embodiments of the present disclosure, each of the longitudinal length and the transverse length of the chamber in the plan view of the chamber is larger than a length of each of the waveguides.

In accordance with some embodiments of the present disclosure, the at least two waveguides include: a first waveguide connected to one side portion of a first side surface of the chamber; a second waveguide connected to one side portion of a second side surface of the chamber; a third waveguide connected to one side portion of a third side surface of the chamber; and a fourth waveguide connected to one side portion of a fourth side surface of the chamber, wherein the first to fourth side surfaces are arranged in this order.

In accordance with some embodiments of the present disclosure, the first waveguide and the third waveguide have the same length as a first length, wherein the second waveguide and the fourth waveguide have the same length as a second length different from the first length.

In accordance with some embodiments of the present disclosure, the second length is larger by ½ of a microwave wavelength than the first length.

In accordance with some embodiments of the present disclosure, the first waveguide has a first length, wherein each of the second waveguide and the fourth waveguide has a second length larger than the first length, wherein the third waveguide has a third length larger than the second length.

In accordance with some embodiments of the present disclosure, the second length is larger by ½ of a microwave wavelength than the first length, wherein the third length is larger by the microwave wavelength than the first length.

In accordance with some embodiments of the present disclosure, the block member includes: a first member disposed to occupy the first space of the chamber and formed to have a non-inclined and flat upper surface having a constant vertical level; and each second member disposed to occupy the second space of each of the waveguides and formed to have an inclined upper surface such that a vertical dimension of the second member decreases as the second member extends from the first member toward an outer end of the second member in a longitudinal direction of the corresponding waveguide.

In accordance with some embodiments of the present disclosure, the difference between phases of the microwaves respectively travelling through the waveguides is adjusted based on a difference between the lengths of the waveguides.

In accordance with some embodiments of the present disclosure, a uniform electric field distribution is generated in the chamber via the adjusting of the difference between the phases of the microwaves, regardless of a microwave treatment time.

In accordance with some embodiments of the present disclosure, the at least two waveguides respectively extend in x-axis and y-axis directions perpendicular to each other, wherein the microwave travelling through the waveguide extending in the x-axis direction has a phase difference of 90 degrees, wherein the microwave travelling through the waveguide extending in the y-axis direction has a phase difference of 180 degrees.

In accordance with some embodiments of the present disclosure, the electric field distribution generated inside the chamber rotates in one direction over time.

In accordance with some embodiments of the present disclosure, an error in the electric field distribution generated in the chamber is maintained at a value smaller than a reference value.

In accordance with some embodiments of the present disclosure, the error in the electric field distribution is controlled via adjusting of a size of the chamber.

Although the present disclosure has been described with reference to the accompanying drawings, the present disclosure is not limited by the embodiments disclosed herein and the drawings, and it is obvious that various modifications may be made by those skilled in the art within the scope of the technical idea of the present disclosure. In addition, although the effects based on the configuration of the present disclosure are not explicitly described and illustrated in the description of the embodiment of the present disclosure above, it is obvious that predictable effects from the configuration should also be recognized.

What is claimed is:

1. A microwave-based heating device comprising:
a chamber having a first space defined therein for receiving a heating-target object therein;
at least two waveguides respectively extending from respective non-central positions in a length direction of at least two side surfaces of the chamber, wherein each of the at least two waveguides has a second space defined therein through which a microwave travels; and
a block member disposed inside each of the chamber and the waveguides so as to occupy the first space of the chamber and the second space of each of the waveguides,
wherein at least one of the waveguides has a different length from a length of each of the others of the waveguides such that a difference between phases of the microwaves respectively travelling through the at least two waveguides occurs,
wherein when the microwaves are applied to the at least two waveguides, an electric field distribution generated in the chamber rotates over time.

2. The microwave-based heating device of claim 1, wherein the chamber is formed in a rectangular parallelepiped shape.

3. The microwave-based heating device of claim 2, wherein a longitudinal length and a transverse length of the chamber in a plan view of the chamber are equal to each other.

4. The microwave-based heating device of claim 3, wherein each of the longitudinal length and the transverse length of the chamber in the plan view of the chamber is larger than a length of each of the waveguides.

5. The microwave-based heating device of claim 4, wherein the at least two waveguides include:
a first waveguide connected to one side portion of a first side surface of the chamber;
a second waveguide connected to one side portion of a second side surface of the chamber;
a third waveguide connected to one side portion of a third side surface of the chamber; and
a fourth waveguide connected to one side portion of a fourth side surface of the chamber,
wherein the first to fourth side surfaces are arranged in this order.

6. The microwave-based heating device of claim 5, wherein the first waveguide and the third waveguide have the same length as a first length,
wherein the second waveguide and the fourth waveguide have the same length as a second length different from the first length.

7. The microwave-based heating device of claim 6, wherein the second length is larger by ½ of a microwave wavelength than the first length.

8. The microwave-based heating device of claim 5, wherein the first waveguide has a first length,
wherein each of the second waveguide and the fourth waveguide has a second length larger than the first length,
wherein the third waveguide has a third length larger than the second length.

9. The microwave-based heating device of claim 8, wherein the second length is larger by ½ of a microwave wavelength than the first length,
wherein the third length is larger by the microwave wavelength than the first length.

10. The microwave-based heating device of claim 1, wherein the block member includes:
a first member disposed to occupy the first space of the chamber and formed to have a non-inclined and flat upper surface having a constant vertical level; and
each second member disposed to occupy the second space of each of the waveguides and formed to have an inclined upper surface such that a vertical dimension of the second member decreases as the second member extends from the first member toward an outer end of the second member in a longitudinal direction of the corresponding waveguide.

11. The microwave-based heating device of claim 1, wherein the difference between phases of the microwaves respectively travelling through the waveguides is adjusted based on a difference between the lengths of the waveguides.

12. The microwave-based heating device of claim 11, wherein a uniform electric field distribution is generated in the chamber via the adjusting of the difference between the phases of the microwaves, regardless of a microwave treatment time.

13. The microwave-based heating device of claim 12, wherein the at least two waveguides respectively extend in x-axis and y-axis directions perpendicular to each other,
wherein the microwave travelling through the waveguide extending in the x-axis direction has a phase difference of 90 degrees,
wherein the microwave travelling through the waveguide extending in the y-axis direction has a phase difference of 180 degrees.

14. The microwave-based heating device of claim 13, wherein the electric field distribution generated inside the chamber rotates in one direction over time.

15. The microwave-based heating device of claim 14, wherein an error in the electric field distribution generated in the chamber is maintained at a value smaller than a reference value.

16. The microwave-based heating device of claim 15, wherein the error in the electric field distribution is controlled via adjusting of a size of the chamber.
